(19) United States
(12) Patent Application Publication
(10) Pub. No.: US 2012/0242180 A1
(43) Pub. Date: Sep. 27, 2012

(54) PERMANENT MAGNET AND MOTOR AND GENERATOR USING THE SAME

(75) Inventors: Yosuke Horiuchi, Tokyo (JP); Shinya Sakurada, Tokyo (JP); Tsuyoshi Kobayashi, Kawasaki-shi (JP); Keiko Okamoto, Kawasaki-shi (JP); Masaya Hagiwara, Yokohama-shi (JP)

(73) Assignee: KABUSHIKI KAISHA TOSHIBA, Tokyo (JP)

(21) Appl. No.: 13/235,679

(22) Filed: Sep. 19, 2011

(30) Foreign Application Priority Data
Mar. 25, 2011 (JP) 2011-067761

(51) Int. Cl. H02K 21/00; H01F 7/02

(52) U.S. Cl. 310/152; 335/302

(57) ABSTRACT

In an embodiment, a permanent magnet includes a composition of RₚFe_{q}ZrᵣMₛCuₜCo_{100-p-q-r-s-t} (R: rare-earth element, M: at least one element selected from Ti and Hf, 10≦p≦15, 24≦q≦40.5, 1.5≦r≦4.5, 0≦s≦3, 1.5≦r+s≦4.5, and 0.8≦t≦13.5 (atomic %)). The permanent magnet has a texture including a main phase which is formed of a Th₂Zn₁₇ type crystal phase, and a grain boundary phase which has a crystal phase having a Zr concentration of from 4 atomic % or more to 35 atomic % or less.

### CROSS-REFERENCE TO RELATED APPLICATION

This application is based upon and claims the benefit of priority from Japanese Patent Application No. 2011-067761, filed on Mar. 25, 2011; the entire contents of which are incorporated herein by reference.

### FIELD

Embodiments described herein relate generally to a permanent magnet and a motor and a generator using the same.

### BACKGROUND

As a high performance permanent magnet, a rare earth magnet such as an Sm—Co based magnet, an Nd—Fe—B based magnet or the like is known. In a case where the permanent magnet is used for the motors of hybrid electric vehicles (HEV) and electric vehicles (EV), the permanent magnet is required to have heat resistance. As a motor for the HEV and EV, there is used a permanent magnet of which heat resistance is improved by partly substituting the Nd of the Nd—Fe—B based magnet with Dy. Since the Dy is one of rare elements, there are demands for a permanent magnet not using the Dy. As highly efficient motors and generators, there are known variable magnetic flux motors and variable magnetic flux generators using two types of magnets such as a variable magnet and a stationary magnet. For the variable magnet, Al—Ni—Co based magnets and Fe—Cr—Co based magnets are used. To provide the variable magnetic flux motors and the variable magnetic flux generators with high performance and high efficiency, it is demanded to enhance the coercive force and magnetic flux density of the variable magnets and stationary magnets.

The Sm—Co based magnet is known that it has a high Curie temperature and exhibits excellent heat resistance in a system not using the Dy, and can realize good motor characteristics and the like at a high temperature. A Sm₂Co₁₇ type magnet among the Sm—Co based magnets can be used as a variable magnet on the basis of its coercive force exhibiting mechanism and the like. The Sm—Co based magnets are also demanded to enhance the coercive force and the magnetic flux density. To provide the Sm—Co based magnet with a high magnetic flux density, it is effective to increase an Fe concentration. The coercive force tends to decrease in a composition region having a high Fe concentration. Therefore, there are demands for a technology to exhibit a large coercive force by the Sm—Co based magnet having a high Fe concentration.

### BRIEF DESCRIPTION OF THE DRAWINGS

FIG. 1 is an SEM image showing in a magnified texture of a permanent magnet of an embodiment.

FIG. 2 is a diagram showing an example of magnetization curves of the permanent magnet of the embodiment.

FIG. 3 is a diagram showing an example of magnetization curves of a conventional Sm—Co based magnet.

FIG. 4 is a diagram showing an example of a differential thermal analysis result of alloy powder used for production of the permanent magnet of the embodiment.

FIG. 5 is a diagram showing a variable magnetic flux motor according to an embodiment.

FIG. 6 is a diagram showing a variable magnetic flux generator according to an embodiment.

### DETAILED DESCRIPTION

According to an embodiment, there is provided a permanent magnet including a composition represented by a formula:

RₚFe_{q}ZrᵣMₛCuₜCo_{100-p-q-r-s-t} (1)

where, R is at least one element selected from rare-earth elements, M is at least one element selected from Ti and Hf, p is a number satisfying 10≦p≦15 atomic, q is a number satisfying 24≦q≦40.5 atomic %, r and s are numbers satisfying 1.5≦r≦4.5 atomic %, 0≦s≦3 atomic % and 1.5≦r+s≦4.5 atomic %, and t is a number satisfying 0.8≦t≦13.5 atomic %. The permanent magnet of the embodiment has a texture including a main phase which is formed of a Th₂Zn₁₇ crystal phase, and a grain boundary phase which has a crystal phase having a Zr concentration in a range from 4 to 35 atomic.

It is generally known that a coercivity generating mechanism of an Sm—Co based magnet is a magnetic domain wall pinning type. The magnetic domain wall pinning type coercivity generating mechanism is considered that a coercive force is exhibited by disturbing the movement of the magnetic wall by a pinning site, which is generated by heat treatment, for example, by a SmCo₅ phase. If the Fe concentration of the Sm—Co based magnet increases, there is a tendency that the exhibition of the coercive force becomes difficult. Its cause is considered that for example, when the Fe concentration increases, the pinning site is not generated easily, and it becomes difficult to provide a high coercive force by the magnetic domain wall pinning type.

As the coercivity generating mechanism, a nucleation type is known independent of the magnetic domain wall pinning type. The nucleation type coercivity generating mechanism exhibits a coercive force by eliminating a site (defect), which tends to be generated on some of crystal grains and becomes a reverse magnetic domain nucleus, and suppressing the generation of the reverse magnetic domain. A Nd—Fe—B based magnet suppresses the generation of the reverse magnetic domain by surrounding the periphery of the main phase by a Nd rich phase, thereby obtaining the nucleation type coercive force. It was considered that the conventional Sm—Co based magnet exhibits the coercive force by the magnetic domain wall pinning type coercivity generating mechanism as described above, and it was not considered that the nucleation type coercivity generating mechanism according to a second phase works.

The permanent magnet of the embodiment is realized by finding that the coercive force based on the nucleation type is exhibited by forming a texture in which a Zr rich second phase (crystal phase having Zr concentration of 4 to 35 atomic %) is generated at the crystal grain boundary of the main phase (main crystal phase) of the Sm—Co based magnet. The nucleation type coercive force based on the Zr rich second phase can also be exhibited in the Sm—Co based magnet having a composition with a high Fe concentration. Therefore, it becomes possible to realize a Sm—Co based permanent magnet which has both a high magnetic flux density and a high coercive force established. The structure of the permanent magnet of the embodiment is described below in detail.

In the composition formula (1), at least one element selected from rare-earth elements including yttrium (Y) is used as the element R. The element R provides a large magnetic anisotropy to the permanent magnet and gives a high coercive force to it. As the element R, at least one selected from samarium (Sm), cerium (Ce), neodynium (Nd) and praseodymium (Pr) is used preferably, and the Sm is used desirably. The performance of the permanent magnet, and particularly the coercive force, can be enhanced with a good reproducibility by having 50 atomic % or more of the element R replaced by the Sm. In addition, it is desirable that 70 atomic % or more of the element R is the Sm.

The content p of the element R is in a range of 10 to 15 atomic %. If the content p of the element R is less than 10 atomic %, a large amount of α-Fe phase precipitates, and a sufficient coercive force cannot be obtained. If the content of the element R exceeds 15 atomic %, a saturation magnetization is decreased considerably. The content p of the element R is preferably determined to be in a range of 10.3 to 13 atomic %, and more preferably in a range of 10.5 to 12.5 atomic.

Iron (Fe) is an element which serves mainly to magnetize the permanent magnet. When a large amount of Fe is contained, the saturation magnetization of the permanent magnet can be enhanced. If the Fe is contained in an excessively large amount, the α-Fe phase precipitates or it becomes difficult to obtain a desired crystalline structure, so that the coercive force might decrease. Therefore, it is determined that the content q of the Fe is in a range of 24 to 40.5 atomic %. The content q of the Fe is preferably in a range of 28 to 38 atomic %, and more preferably in a range of 30 to 36 atomic.

Zirconium (Zr) is an element effective for an enhancement of the performance of the permanent magnet, and particularly an enhancement of the coercive force. Content r of the Zr is determined to be in a range of 1.5 atomic % or more to 4.5 atomic % or less. When the content r of the Zr is determined to be 1.5 atomic % or more, the Zr rich second phase becomes easy to appear in the texture of the permanent magnet. Thus, a large coercive force can be exhibited in the permanent magnet having a composition with a high Fe concentration. If the content r of the Zr exceeds 4.5 atomic %, magnetization is decreased considerably. The content r of the Zr is preferably in a range of 1.7 to 4 atomic %, and more preferably in a range of 2 to 3.5 atomic %.

As the element M, at least one element selected from titanium (Ti) and hafnium (Hf) is used. The element M is an arbitrary element and can be contained by partly replacing the Zr. When the element M is blended, the magnetic anisotropy is increased, and a stable and large coercive force can be exhibited in the permanent magnet having a composition with a high Fe concentration. When the element M is contained excessively, the magnetization is decreased considerably. Therefore, it is determined that the content s of the element M is 3 atomic % or less. Since the element M is a substitution element of Zr, it is contained so that a total amount (r+s) of the content r of the Zr and the content s of the element M becomes 4.5 atomic % or less.

The content s of the element M is preferably 2.3 atomic % or less. The content s of the element M is preferably less than 50 atomic % relative to the total amount (r+s) of the content r of the Zr and the content s of the element M, more preferably 40 atomic % or less, and still more preferably 35 atomic % or less. The element M may be either Ti or Hf, and when the Ti is used for 50 atomic % or more of the element M, the effect of enhancing the coercive force of the permanent magnet can be improved. Since the Hf is expensive, it is preferably used in a small amount as the element M. The content of the Hf is preferably less than 20 atomic % of the element M.

Copper (Cu) is an element for making the permanent magnet exhibit a high coercive force. The blending amount t of the Cu is in a range of 0.8 to 13.5 atomic %. If the blending amount t of the Cu is less than 0.8 atomic %, it is difficult to obtain a high coercive force. If the blending amount t of the Cu exceeds 13.5 atomic, magnetization is decreased considerably. The blending amount t of the Cu is preferably in a range of 3 to 10.6 atomic %, and more preferably in a range of 4 to 7.1 atomic %.

Cobalt (Co) is an element which serves to magnetize the permanent magnet and is required to exhibit a high coercive force. If the Co is contained in a large amount, a Curie temperature becomes high, and the thermal stability of the permanent magnet is improved. If the Co content is excessively small, the above effects cannot be obtained sufficiently. If the Co content is excessively large, the ratio of the Fe content decreases relatively, and magnetization is decreased. Therefore, the Co content is determined considering the contents of the elements R and Zr and the elements M and Cu, so that the Fe content satisfies the above-described range.

The Co may be partly substituted by at least one element A selected from nickel (Ni), vanadium (V), chromium (Cr), manganese (Mn), aluminum (Al), gallium (Ga), niobium (Nb), tantalum (Ta) and tungsten (W). These substitution elements contribute to improvement of the magnet characteristics such as a coercive force. But, if the Co is excessively substituted by the element A, magnetization might be decreased, so that the substitution amount by the element A is preferably determined to be 20 atomic % or less of the Co.

The permanent magnet of the embodiment has a texture which has a Th₂Zn₁₇ type crystal phase (crystal phase having Th₂Zn₁₇ type structure/2-17 phase) as a main phase. According to the permanent magnet having the 2-17 phase as the main phase, high magnet characteristics such as a high coercive force can be obtained. The main phase means a phase having a maximum volume ratio among the constituent phases such as a crystal phase and a noncrystalline phase configuring the permanent magnet. It is preferable that the 2-17 phase has a volume ratio of 50% or more. A volume ratio the individual phases configuring the texture of the permanent magnet is comprehensively determined by observing through an electron microscope or an optical microscope, X-ray diffraction together.

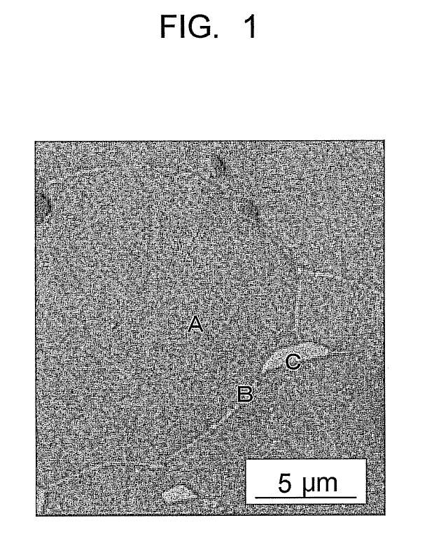

As shown in a reflected electron image based on an SEM (Scanning Electron Microscope) shown in FIG. 1, the crystal grain boundary of the main phase (indicated by A in the figure) including the 2-17 phase has a grain boundary phase (Zr rich grain boundary phase indicated by B in the figure) having a crystal phase with a Zr concentration in a range of 4 to 35 atomic %. Thus, the Zr rich grain boundary phase (non-magnetic phase) B is present in the crystal grain boundary of the main phase A, so that the generation of the reverse magnetic domain due to the reversal nucleation within the main phase can be suppressed. Therefore, the permanent magnet having the composition represented by the formula (1) can exhibit the coercive force according to the nucleation type, which was not considered to be exhibited by the conventional Sm—Co based magnet.

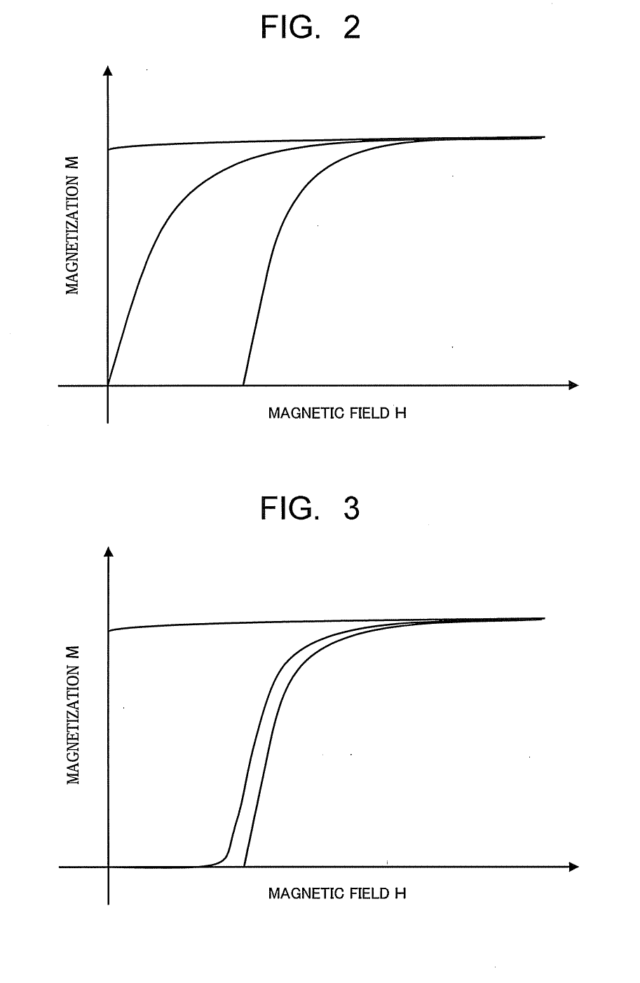

It can be confirmed with reference to an initial magnetization curve whether or not the coercive force of the permanent magnet is a nucleation type. When the coercive force of the permanent magnet is a nucleation type, the initial magnetization curve shows a steep rise when an external magnetic field is applied in a direction parallel to the direction of an easy axis of magnetization to the magnet in an initial magnetization state as shown in FIG. 2. FIG. 2 shows magnetization curves of the permanent magnet of the embodiment, and it is seen that the coercive force of the permanent magnet of the embodiment is a nucleation type.

Meanwhile, when the coercive force of the permanent magnet is in a magnetic domain wall pinning type, the magnetization is hardly exhibited until a prescribed external magnetic field is applied as shown in FIG. 3. A magnetization curve remains on the same level at a point where the magnetization is substantially zero, and the magnetization curve rises upward suddenly when a certain degree of the external magnetic field is applied. FIG. 3 shows magnetization curves of a conventional Sm—Co based magnet. It is apparent from the comparison of FIG. 2 and FIG. 3 that it can be judged from the initial magnetization curve of the permanent magnet whether the coercive force is a nucleation type.

The Zr rich grain boundary phase is generated by applying the production conditions described later even when the Fe concentration of the main phase is high, so that it becomes possible to realize a permanent magnet that achieves both a high magnetic flux density based on the high Fe concentration of the main phase and a high coercive force based on the nucleation type. In addition, the permanent magnet of the embodiment is also excellent in heat resistance on the basis of its composition and crystalline structure. Therefore, it becomes possible to provide the permanent magnet having the improved heat resistance, which achieves both the high coercive force and the high magnetic flux density, without using a rare element such as Dy. Similar to the conventional Sm—Co based magnet, the permanent magnet of the embodiment can be applied as a variable magnet depending on the coercive force value, so that a permanent magnet useful for variable magnetic flux motors and the like can be provided.

The Zr concentration of the grain boundary phase that exhibits the coercive force of the nucleation type is determined to be in a range of 4 to 35 atomic %. If the Zr concentration of the Zr rich crystal phase configuring the grain boundary phase is less than 4 atomic %, an effect of suppressing the reversal nucleation in the main phase is small, and a sufficient coercive force cannot be obtained. If the Zr concentration of the grain boundary phase exceeds 35 atomic %, the Zr concentration in the main phase decreases, the 2-17 phase becomes instable, and the coercive force lowers as a result. The Zr concentration of the Zr rich crystal phase is preferably in a range of 4 to 20 atomic %, and more preferably in a range of 4.5 to 15 atomic %.

In addition, the Zr rich grain boundary phase preferably has a thickness in a range of 20 to 500 nm. If the thickness of the Zr rich grain boundary phase is less than 20 nm, the effect of suppressing the reversal nucleation becomes insufficient. If the thickness of the grain boundary phase exceeds 500 nm, a volume fraction of the main phase decreases, and there is a possibility that sufficient magnetization cannot be obtained. The thickness of the Zr rich grain boundary phase is preferably in a range of 25 to 400 nm, and more preferably in a range of 30 to 300 nm. The Zr rich grain boundary phase is preferably laid to surround the entire periphery of the main phase. Thus, the reversal nucleation in the main phase and the generation of the reverse magnetic domain based on it can be suppressed more effectively.

The concentration of the element R in the Zr rich grain boundary phase is preferably in a range of 5 to 35 atomic %. In addition, it is more preferable that Sm is used as at least part of the element R, and it is desirable that the Sm concentration of the Zr rich grain boundary phase is in a range of 5 to 35 atomic %. Since the above grain boundary phase has a high magnetic anisotropy, the permanent magnet can be provided with a larger coercive force. If the concentration (such as Sm concentration) of the element R of the Zr rich grain boundary phase is less than 5 atomic, an effect of increasing the magnetic anisotropy cannot be obtained sufficiently. If the concentration (such as Sm concentration) of the element R exceeds 35 atomic %, the Sm concentration in the main phase decreases, and the 2-17 phase becomes unstable. The concentration (such as Sm concentration) of the element R of the Zr rich grain boundary phase is preferably in a range of 5 to 20 atomic %, and more preferably in a range of 6 to 15 atomic %.

In the permanent magnet of the embodiment, the Zr concentration and the concentration (such as Sm concentration) of the element R in the main phase and the grain boundary phase can be measured by an SEM-EDX (energy dispersive X-ray spectrometry). For example, in the reflected electron image based on the SEM shown in FIG. 1, the Zr concentration of the main phase can be identified by measuring the Zr concentration at a portion A by the SEM-EDX. The Zr concentration and Sm concentration of the grain boundary phase can be identified by measuring the Zr concentration and Sm concentration of a portion B by the SEM-EDX. The Zr concentration and Sm concentration of the main phase and the grain boundary phase can also be measured by a TEM-EDX other than the SEM-EDX.

If the Zr rich grain boundary phase is thin, the measurement of the Zr concentration and Sm concentration of the grain boundary phase by the SEM-EDX might become difficult. In such a case, as shown in FIG. 1, the Zr concentration at a phase (indicated by C in the figure) present at a crystal triple point showing the same color as that of the grain boundary phase, which is continuous to the Zr rich grain boundary phase B, can be defined as the Zr concentration of the grain boundary phase. It is because the contrast of the reflected electron image reflects the composition ratio, and when the grain boundary phase and the crystal triple point have the same color (contrast), it can be interpreted that the triple point represents the composition of the grain boundary phase. The above measurement is performed at 20 points of an arbitrary grain boundary phase of a single test sample, and the average value of the obtained results is determined as the Zr concentration, Sm concentration and the like of the grain boundary phase.

The thickness of the Zr rich grain boundary phase can be measured by SEM observation. First, the sintered body is undergone the SEM observation. The sintered body is crushed to a size of about 1 to 3 mm squares, an observation surface is smoothened by polishing, and observation is performed at a magnification of 3000 times. The thickness of the crystal grain boundary observed is regarded as the thickness of the grain boundary phase. If the thickness of the grain boundary phase is small, the observation may be performed at a magnification of 5000 times. Since the grain boundary phase becomes clear, the SEM observation is preferably performed on the SEM reflected electron image. If the thickness of the grain boundary phase is very small, the thickness of the grain boundary phase may be measured by performing the TEM observation.

For example, the permanent magnet of the embodiment is produced as follows. First, the alloy powder containing a predetermined amount of elements is produced. The alloy powder is prepared by, for example, forming an alloy thin strip in flake form by a strip casting method and crushing it. According to the strip casting method, it is preferable to obtain a thin strip with a thickness of 1 mm or less by pouring a molten alloy to a cooling roll which rotates at a circumferential velocity of 0.1 to 20 m/sec and solidifying continuously. If the cooling roll has a circumferential velocity of less than 0.1 m/sec, the thin strip tends to have variable compositions, and if the circumferential velocity exceeds 20 m/sec, the crystal grains are miniaturized into a single-domain size or less, and good magnetic characteristics cannot be obtained. The circumferential velocity of the cooling roll is more preferably in a range of 0.3 to 15 m/sec, and still more preferably in a range of 0.5 to 12 m/sec.

The alloy powder may be prepared by crushing the alloy ingot obtained by casting the molten metal by an arc melting method or a high-frequency melting method. Other methods of preparing the alloy powder include a mechanical alloying method, a mechanical grinding method, a gas atomizing method, a reduction and diffusion method and the like. The alloy powders prepared by the above methods may be used. The alloy powder obtained as described above or the alloy before crushing may be homogenized by a thermal treatment, if necessary. The flake or the ingot is crushed by a jet mill, a ball mill, or the like. The crushing is preferably performed in an inert gas atmosphere or an organic solvent to prevent the alloy powder from being oxidized.

The alloy powder is then filled in a mold which is disposed in an electromagnet or the like and undergone pressure forming while applying a magnetic field to form a green compact with crystal axes oriented. A sintered body having a large coercive force can be obtained by sintering the green compact under appropriate conditions. That is, a texture in which the periphery of the main phase is surrounded by the Zr rich grain boundary phase can be obtained by sintering under temperature conditions such as a melting initiation temperature T_{L} or higher of a low melting point Zr-rich phase (phase which constitutes the grain boundary) and a temperature T_{P} or below at which the main phase powder does not become a sufficient liquid phase.

The melting initiation temperature T_{L} of the Zr-rich phase and the temperature T_{P} at which the main phase powder does not become a sufficient liquid phase can be determined by a differential thermal analysis. The shape of the test sample used for the differential thermal analysis is not necessarily to be powder. Since the low melting point Zr-rich phase and the main phase are considered to be formed when the alloy is produced, the alloy thin strip in flake form obtained by the strip casting method or the alloy ingot produced by arc melting may be used. The powder used for sintering may be used by separately preparing and mixing two or more types of powder having a different melting point.

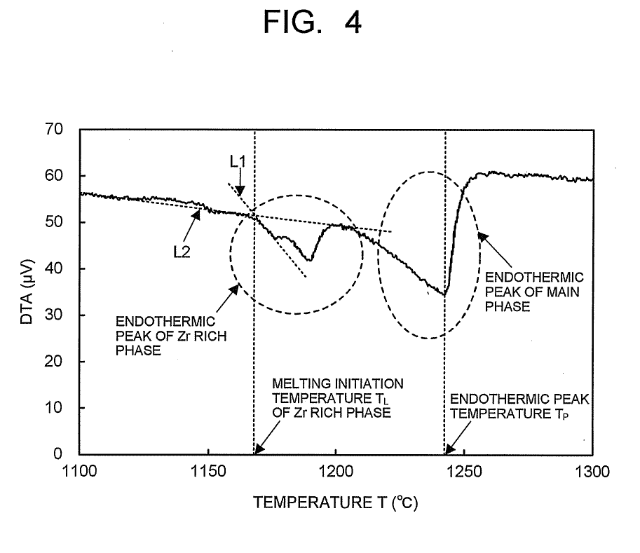

FIG. 4 shows an example of the results obtained by a differential thermal analysis performed on alloy powder which is used to produce the permanent magnet of the embodiment. In FIG. 4, a maximum endothermic peak is an endothermic peak due to melting of the main phase, and its peak top temperature is determined to be temperature T_{P} at which the main phase powder does not become a liquid phase sufficiently. A peak, which is smaller than that of the endothermic reaction of the main phase, is observed on the side of the temperature lower than that of the peak of the endothermic reaction of the main phase. It is the endothermic peak due to the melting of the Zr-rich phase. The point of contact (intersection point between L1 and tangential line L2 of background) of a rise of this peak is determined as the melting initiation temperature T_{L}. The above temperatures can be used to represent an appropriate sintering temperature T (° C.) as follows.

T_{L}−10(° C.)<T<T_{P}+10(° C.) (2)

A metal texture in which the periphery of the main phase is surrounded by the Zr-rich phase is formed by sintering at a temperature satisfying the formula (2). If the sintering temperature is not higher than (T_{L}−10° C.), a satisfactory liquid phase cannot be obtained, and a texture of a nucleation type cannot be obtained. If the sintering temperature is not lower than (T_{P}+10° C.), the main phase also becomes a liquid phase, so that the constituent elements of the main phase and the constituent elements of the Zr-rich phase are dispersed, and the Zr concentration in the grain boundary becomes small. Therefore, a clear Zr rich grain boundary phase cannot be obtained. In addition, Sm and the like evaporate from the alloy powder, so that the magnetic characteristics such as a coercive force cannot be enhanced sufficiently.

Sintering time at the above temperature is preferably 0.5 to 15 hours. A denser sintered body can be obtained. If the sintering time is less than 0.5 hour, the density of the sintered body does not become uniform. If the sintering time exceeds 15 hours, Sm and the like evaporate from the alloy powder, and good magnetic characteristics cannot be obtained. The sintering time is more preferably in a range of 1 to 10 hours, and still more preferably in a range of 1 to 4 hours. It is preferable that the green compact is sintered in vacuum or an inert gas atmosphere such as an argon gas to prevent it from being oxidized.

The obtained sintered body may be used as it is as a permanent magnet or may be used as a permanent magnet after the heating treatment at an appropriate temperature after sintering. For example, defects in the crystal are decreased by performing the heating treatment at a temperature in a range of 1100 to 1200° C. or a combination of the heating treatment at a high temperature and the heating treatment at a lower temperature, so that further improvement of the coercive force of the permanent magnet can be expected. Magnet materials (such as an alloy powder, a sintered body, and a powder obtained by pulverizing it) configuring the permanent magnet of the embodiment can also be used as a bond magnet.

The permanent magnet of the embodiment can be used as stationary and variable magnets for various motors and generators. In a case where it is used as the variable magnet, the coercive force of the permanent magnet is preferably 500 kA/m or less. When the permanent magnet of the embodiment is used as the stationary magnet and the variable magnet, the variable magnetic flux motor and the variable magnetic flux generator are configured. The technologies disclosed in the prior references can be applied to the structure and the drive system of the variable magnetic flux motor. By using the permanent magnet of the embodiment as the stationary and variable magnets of a variable magnetic flux drive system, the system can be made to be highly efficient, compact, inexpensive and the like.

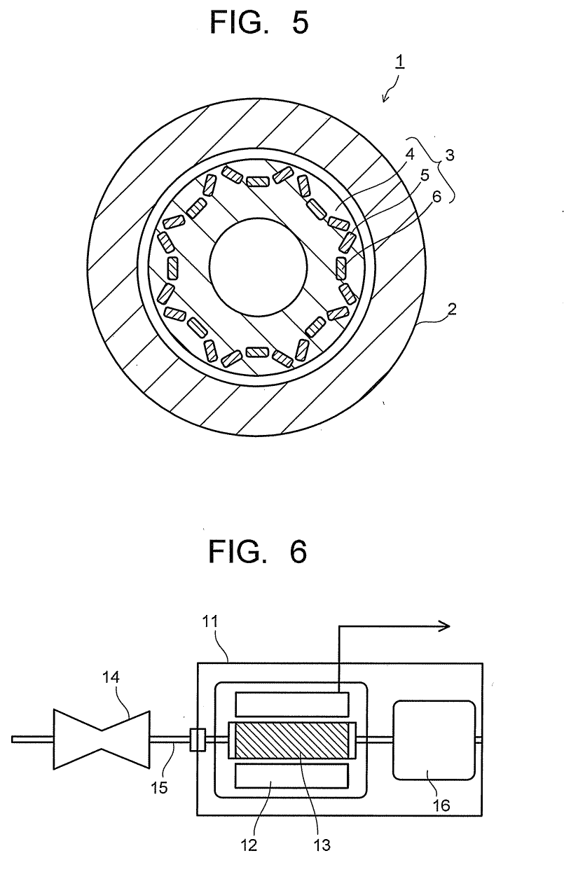

The motor and the generator of the embodiment are described below with reference to the drawings. FIG. 5 shows a variable magnetic flux motor of the embodiment, and FIG. 6 shows a variable magnetic flux generator of the embodiment. Usage of the permanent magnet of the embodiment is not limited to the variable magnetic flux motors and the variable magnetic flux generators. The permanent magnet of the embodiment can also be applied to ordinary permanent magnet motors and generators, and it can also be made to be highly efficient, compact, inexpensive and the like.

In a variable magnetic flux motor 1 shown in FIG. 5, a rotor 3 is disposed within a stator 2. Stationary magnets 5 using the permanent magnet of the embodiment and variable magnets 6 using the permanent magnet having a coercive force lower than that of the stationary magnets 5 are arranged in a core 4 of the rotor 3. A magnetic flux density (flux content) of the variable magnets 6 is variable. Since the variable magnets 6 have a magnetization direction intersecting at right angles with a Q-axis direction, they are not influenced by Q-axis current and can be magnetized by D-axis current. The rotor 3 is provided with magnetizing winding (not shown), and it is configured so that the magnetic field acts directly on the variable magnets 6 by passing an electric current from a magnetizing circuit to the magnetizing winding.

According to the permanent magnet of the embodiment, for example, the stationary magnets 5 having a coercive force of exceeding 500 kA/m and the variable magnets 6 having a coercive force of 500 kA/m or less can be obtained by varying the various conditions of the production method described above. In the variable magnetic flux motor 1 shown in FIG. 5, the permanent magnet of the embodiment can be used for both of the stationary magnets 5 and the variable magnets 6, but the permanent magnet of the embodiment may be used for either of the above magnets. Since the variable magnetic flux motor 1 can output a large torque from a small apparatus size, it is suitable for the motors of hybrid electric vehicles, electric vehicles and the like, which are demanded to have a high output and a small size.

A variable magnetic flux generator 11 shown in FIG. 6 is provided with a stator 12 using the permanent magnet of the embodiment. A rotor 13 arranged inside the stator 12 is connected to a turbine 14, which is disposed at one end of the variable magnetic flux generator 11, through a shaft 15. The turbine 14 is configured to be rotated by, for example, a fluid supplied from outside. Instead of the turbine 14 which is rotated by the fluid, the shaft 15 can also be rotated by transmitting dynamic rotations such as regenerative energy or the like of the automobile. For the stator 12 and the rotor 13, a variety of known structures can be adopted.

And, the shaft 15 is in contact with a commutator (not shown) which is disposed on the side opposite to the turbine 14 with respect to the rotor 13, and an electromotive force generated by the rotations of the rotor 13 is raised to a system voltage and transmitted via a phase separation bus and a main transformer (not shown) as the output of the variable magnetic flux generator 11. The rotor 13 is electrically charged by static electricity from the turbine 14 or by axis current associated with the power generation. Therefore, the variable magnetic flux generator 11 is provided with a brush 16 for discharging the electrical charge of the rotor 13.

Examples and their evaluated results are described below.

### Examples 1 to 3

Individual raw materials were weighed to have the compositions shown in Table 1 and arc-melted in an Ar gas atmosphere to form alloy ingots. The alloy ingots were undergone a differential thermal analysis, and a melting initiation temperature T_{L} of the Zr-rich phase and a temperature T_{P} at which the main phase powder does not become a liquid phase sufficiently were determined according to the above-described method. For measurement, it was determined that a differential thermal analyzer TGD7000 made by ULVAC-RIKO, Inc. was used, a measuring temperature range was from room temperature to 1650° C., a heating rate was 10° C./min, and an atmosphere had Ar gas (flow rate: 100 mL/min). The amount of the test sample was about 300 mg, alumina was used for the vessel, and alumina was used for reference. The temperature T_{L} and the temperature T_{P} of the individual alloy ingots obtained are shown in Table 2.

Then, the individual alloy ingots were coarsely crushed and then finely ground by a jet mill to prepare alloy powders. The alloy powders were pressed in a magnetic field to prepare green compacts, which were then sintered in an Ar gas atmosphere at the temperatures shown in Table 2 for three hours, and subsequently heated at 1170° C. for three hours to produce sintered bodies. The sintered bodies were held at 850° C. for four hours and cooled to room temperature to obtain target sintered magnets. The sintered magnets have the compositions as shown in Table 1. The compositions of the individual magnets were confirmed by an ICP method. The Zr concentration and Sm concentration in a grain boundary phase and its thickness were measured according to the above-described method. The magnetic characteristics of the sintered magnets were evaluated by a BH tracer, and coercive forces were measured. The results are shown in Table 2.

### Comparative Examples 1 and 2

The alloy powder of the same composition as in Example 1 was used except that the sintering temperature was changed to those shown in Table 2, and sintered magnets were produced under the same conditions. The Zr concentration and Sm concentration in a grain boundary phase and its thickness were measured according to the above-described method. The magnetic characteristics of the sintered magnets were evaluated by the EH tracer, and coercive forces were measured. The results are shown in Table 2.

### Examples 4 to 6

Individual raw materials were weighed to have the compositions shown in Table 1 and arc-melted in an Ar gas atmosphere to form alloy ingots. The individual alloy ingots were attached to a quartz nozzle and melted by high-frequency induction heating. The each molten metal was poured to a cooling roll which rotates at a circumferential velocity of 0.6 m/sec and continuously solidified to form a thin strip. The thin strip was coarsely crushed and then finely ground by a jet mill to form alloy powder. The individual alloy powders were pressed in a magnetic field to make green compacts, which were then sintered in an Ar gas atmosphere at the temperatures shown in Table 2 for one hour, and quenched to room temperature to produce sintered bodies. The sintered bodies were held at 850° C. for four hours and cooled to room temperature to obtain target sintered magnets. The compositions of the sintered magnets are shown in table 1. The Zr concentration and Sm concentration in a grain boundary phase and its thickness were measured according to the above-described method. The magnetic characteristics of the sintered magnets were evaluated by the BH tracer, and coercive forces were measured. The results are shown in Table 2.

### Comparative Examples 3 and 4

The alloy powder having the same compositions as in Example 4 was used to produce sintered magnets under the same conditions except that the sintering temperature was changed to those shown in Table 2. The Zr concentration and Sm concentration in a grain boundary phase and its thickness were measured according to the above-described method. The magnetic characteristics of the sintered magnets were evaluated by the BH tracer, and coercive forces were measured. The results are shown in Table 2.

### Examples 7 to 10

Green compacts were produced in the same manner as in Example 1 except that the alloy powders having the compositions shown in Table 1 were used. Then, the green compacts were sintered in an Ar gas atmosphere at the temperatures shown in Table 2 for three hours and quenched to room temperature to produce sintered bodies. The sintered bodies were held at 830° C. for eight hours and cooled to room temperature to obtain target sintered magnets. The compositions of the sintered magnets are shown in Table 1. The Zr concentration and Sm concentration in a grain boundary phase and its thickness were measured according to the above-described method. The magnetic characteristics of the sintered magnets were evaluated by the BH tracer, and coercive forces were measured. The results are shown in Table 2.

### Comparative Example 5

The alloy powder of the same compositions as in Example 7 was used except that the sintering temperature was changed to the temperature shown in Table 1, and a sintered magnet was produced under the same conditions. The Zr concentration and Sm concentration in a grain boundary phase and its thickness were measured according to the above-described method. The magnetic characteristics of the sintered magnet were evaluated by the BH tracer, and a coercive force was measured. The results are shown in Table 2.

### Comparative Examples 6 to 10

Green compacts were produced in the same manner as in Example 1 except that the alloy powders having the compositions shown in Table 1 were used. Then, the green compacts were sintered in an Ar gas atmosphere at the temperatures shown in Table 2 for two hours and quenched to room temperature to produce sintered bodies. The sintered bodies were held at 800° C. for four hours and cooled to room temperature to obtain target sintered magnets. The compositions of the sintered magnets are shown in Table 1. The Zr concentration and Sm concentration in a grain boundary phase and its thickness were measured according to the above-described method. The magnetic characteristics of the sintered magnets were evaluated by the BH tracer, and coercive forces were measured. The results are shown in Table 2.

TABLE 1

| | Magnet Composition (atomic %) |
|---|---|
| Example 1 | (Sm_{0.9}Nd_{0.1})_{11.24}Fe_{24.85}Zr_{1.95}Cu_{4.70}Co_{57.26} |
| Example 2 | Sm_{10.87}Fe_{26.74}Zr_{3.03}Ti_{0.53}Cu_{5.53}Co_{53.30} |
| Example 3 | (Sm_{0.9}Pr_{0.05})_{10.99}Fe_{28.48}Zr_{2.23}Cu_{4.81}Co_{53.49} |
| Example 4 | Sm_{11.30}Fe_{30.16}Zr_{3.10}Cu_{5.32}Co_{50.12} |
| Example 5 | Sm_{11.30}Fe_{30.16}Zr_{3.10}Cu_{5.32}Co_{50.12} |
| Example 6 | Sm_{11.30}Fe_{30.16}Zr_{3.10}Cu_{5.32}Co_{50.12} |
| Example 7 | (Sm_{0.8}Nd_{0.2})_{11.46}Fe_{27.35}Zr_{2.38}Cu_{4.94}Mn_{1.32}Co_{52.25} |
| Example 8 | Sm_{11.11}Fe_{26.67}Zr_{3.11}Cu_{4.62}Ga_{1.16}Co_{53.33} |
| Example 9 | (Sm_{0.8}Pr_{0.2})_{10.75}Fe_{27.67}Zr_{3.12}Cu_{5.80}Cr_{1.78}Co_{50.88} |
| Example 10 | Sm_{10.53}Fe_{28.63}Zr_{2.15}Cu_{5.28}Co_{53.41} |
| Comparative | (Sm_{0.9}Nd_{0.1})_{11.24}Fe_{24.85}Zr_{1.95}Cu_{4.70}Co_{57.26} |
| Example 1 | |
| Comparative | (Sm_{0.9}Nd_{0.1})_{11.24}Fe_{24.85}Zr_{1.95}Cu_{4.70}Co_{57.26} |
| Example 2 | |
| Comparative | Sm_{11.30}Fe_{30.16}Zr_{3.10}Cu_{5.32}Co_{50.12} |
| Example 3 | |
| Comparative | Sm_{11.30}Fe_{30.16}Zr_{3.10}Cu_{5.32}Co_{50.12} |
| Example 4 | |
| Comparative | (Sm_{0.8}Nd_{0.2})_{11.76}Fe_{27.35}Zr_{2.38}Cu_{4.94}Mn_{1.32}Co_{52.25} |
| Example 5 | |
| Comparative | Sm_{11.11}Fe_{48.89}Zr_{3.11}Cu_{4.62}Ga_{1.16}Co_{31.11} |
| Example 6 | |
| Comparative | (Sm_{0.8}Pr_{0.2})_{10.75}Fe_{27.67}Zr_{1.16}Cu_{5.80}Cr_{1.78}Co_{52.84} |
| Example 7 | |
| Comparative | Sm_{10.53}Fe_{28.63}Zr_{5.37}Cu_{5.28}Co_{50.19} |
| Example 8 | |
| Comparative | Sm_{10.87}Fe_{26.74}Zr_{3.03}Ti_{0.53}Cu_{0.71}Co_{58.12} |
| Example 9 | |
| Comparative | Sm_{9.62}Fe_{30.73}Zr_{3.16}Cu_{5.42}Co_{51.07} |
| Example 10 | |

TABLE 2

| | Sintering conditions | | | Grain boundary phase | | | |
|---|---|---|---|---|---|---|---|
| | | | Sintering | Zr | Sm | | Coercive |
| | T_{L} | Tₚ | temperature | concentration | concentration | Thickness | force |
| | (° C.) | (° C.) | (° C.) | (atomic %) | (atomic %) | (nm) | (kA/m) |
| E1 | 1185 | 1250 | 1210 | 4.8 | 6.8 | 25 | 910 |
| E2 | 1180 | 1230 | 1210 | 15.9 | 7.8 | 370 | 1420 |
| E3 | 1175 | 1230 | 1210 | 11.2 | 10.6 | 50 | 1670 |
| E4 | 1140 | 1215 | 1180 | 6.5 | 22.8 | 220 | 920 |
| E5 | 1140 | 1251 | 1155 | 4.4 | 7.4 | 20 | 860 |
| E6 | 1140 | 1215 | 1205 | 12.2 | 11.4 | 280 | 850 |
| E7 | 1150 | 1205 | 1180 | 5.7 | 11.7 | 165 | 870 |
| E8 | 1145 | 1200 | 1180 | 4.8 | 5.4 | 250 | 900 |
| E9 | 1165 | 1220 | 1180 | 21.5 | 8.6 | 420 | 980 |
| E10 | 1145 | 1210 | 1180 | 6.2 | 7.3 | 380 | 880 |
| CE1 | 1185 | 1250 | 1265 | 3.4 | 12.5 | 16 | 270 |
| CE2 | 1185 | 1250 | 1170 | 2.6 | 11.4 | 13 | 160 |
| CE3 | 1140 | 1215 | 1300 | 3.3 | 11.9 | 12 | 80 |
| CE4 | 1140 | 1215 | 1050 | 3.1 | 11.2 | 8 | 45 |
| CE5 | 1150 | 1205 | 1145 | 4.0 | 8.4 | 17 | 250 |
| CE6 | 1100 | 1195 | 1180 | 4.3 | 12.5 | 22 | 25 |
| CE7 | 1185 | 1230 | 1200 | 0.5 | 11.9 | 14 | 18 |
| CE8 | 1125 | 1190 | 1175 | 28.9 | 25.8 | 340 | 32 |
| CE9 | 1200 | 1250 | 1220 | 6.9 | 15.8 | 49 | 15 |
| CE10 | 1160 | 1215 | 1200 | 14.9 | 21.7 | 124 | 90 |

E1 to E10 = Example 1 to Example 10;
CE1 to CE10 = Comparative Example 1 to Comparative Example 10

It is apparent from Table 2 that all the sintered magnets of Examples 1 to 10 have a high coercive force and excellent magnetic characteristics. On the other hand, the sintered magnets of Comparative Examples 1 to 5 are low in the Zr concentration in the grain boundary phase and also small in thickness, so that a satisfactory coercive force is not obtained. And, since the sintered magnets of Comparative Examples 6 to 10 are different in composition, a satisfactory coercive force is not obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A permanent magnet, comprising:
a composition represented by a formula:
RₚFe_{q}ZrᵣMₛCuₜCo_{100-p-q-r-s-t}
where, R is at least one element selected from rare-earth elements,
M is at least one element selected from Ti and Hf,
p is a number satisfying 10≦p≦15 atomic %,
q is a number satisfying 24≦q≦40.5 atomic %,
r and s are numbers satisfying 1.5≦r≦4.5 atomic %, 0≦s≦3 atomic % and 1.5≦r+s≦4.5 atomic %,
t is a number satisfying 0.8≦t≦13.5 atomic; and
a texture comprising a main phase including a Th₂Zn₁₇ crystal phase, and a grain boundary phase including a crystal phase having a Zr concentration in a range from 4 to 35 atomic %.

2. The permanent magnet according to claim 1, wherein the grain boundary phase has a thickness in a range from 20 to 500 nm.

3. The permanent magnet according to claim 1, wherein a concentration of the element R in the grain boundary phase is in a range from 5 to 30 atomic %.

4. The permanent magnet according to claim 1, wherein the element R contains at least Sm, and a Sm concentration in the grain boundary phase is in a range from 5 to 30 atomic %.

5. The permanent magnet according to claim 1, wherein an initial magnetization curve of the permanent magnet indicates a nucleation type.

6. The permanent magnet according to claim 1, wherein a content of the element M is less than 50 atomic % relative to a total content of the Zr and the element M.

7. The permanent magnet according to claim 1, wherein 50 atomic % or more of the element R is Sm.

8. The permanent magnet according to claim 1, wherein 20 atomic % or less of the Co is substituted by at least one element A selected from Ni, V, Cr, Mn, Al, Ga, Nb, Ta and W.

9. A motor comprising the permanent magnet according to claim 1.

10. A generator comprising the permanent magnet according to claim 1.
